(19) United States
(12) Patent Application Publication
(10) Pub. No.: US 2025/0120408 A1
(43) Pub. Date: Apr. 17, 2025

(54) DE-FLAVORED PEA PROTEIN CONCENTRATES AND METHODS OF MANUFACTURE

(71) Applicants: CORN PRODUCTS DEVELOPMENT, INC., WESTCHESTER, IL (US); INGREDION PLANT BASED PROTEIN SPECIALTIES (CANADA), INC., Vancouver (CA)

(72) Inventors: Lauren ANDERSON, Bridgewater, NJ (US); Sharon BENDER, Bridgewater, NJ (US); Stella COUTROS-HOFFMANN, Bridgewater, NJ (US); Yadunandan DAR, Bridgewater, NJ (US); Oyelayo JEGEDE, Bridgewater, NJ (US); Marjorie WELCHOFF, Bridgewater, NJ (US); Vishnu MURTHY, Bridgewater, NJ (US); Xavier O'CONNELL, Bridgewater, NJ (US); Jay SANGHANI, Bridgewater, NJ (US); Tushar SHAH, Bridgewater, NJ (US); Roxanna SHARIFF, Bridgewater, NJ (US); Robert SKORGE, Bridgewater, NJ (US); Delong SONG, Bridgewater, NJ (US); Meng XUE, Bridgewater, NJ (US); Alexandra CUMMINS, Bridgewater, NJ (US)

(21) Appl. No.: 18/683,844

(22) PCT Filed: Aug. 16, 2022
(86) PCT No.: PCT/US2022/040455

§ 371 Date: Feb. 15, 2024

Related U.S. Application Data
(60) Provisional application No. 63/235,229, filed on Aug. 20, 2021.

(51) Int. Cl. A21D 13/045; A21D 2/26; A21D 13/066; A23J 3/14; A23L 5/20; A23L 11/30; A23L 33/185

(52) U.S. Cl. CPC A21D 13/045; A21D 2/266; A21D 13/066; A23J 3/14; A23L 5/21; A23L 11/31; A23L 33/185

(57) ABSTRACT

This specification discloses methods for removing unwanted flavors from legume protein concentrates, which are powdered legume compositions that have been classified to increase the protein compared to the protein content of the base legume. In at least some embodiments the methods are used to make de-flavored pea protein concentrates. Advantageously, the methods are selected to minimize damage to the de-flavored legume protein concentrates by reference to percent change of denaturation enthalpy compared an untreated legume protein concentrate.

The technology disclosed in this specification pertains to legume protein concentrates that have been processed to remove unwanted flavors.

Legumes are high in protein, gluten free making, and are commonly ground to form a powdered compositions, which in this specification like flours and protein concentrates. This specification focuses on legume protein concentrates and preferably pea protein concentrates, which are powdered compositions having higher relative legume protein to the protein content naturally in the legume. Within the context of legume protein products, legume protein concentrates have protein content from about 50% to about 70%. Legume protein products having less protein content may be called legume flours. Legume protein products having more than about 70% protein may be called protein isolates. Relative to legume flours, legume protein concentrates may be preferred for their higher protein content. Relative legume protein isolates, legume protein concentrates may be preferred because they are not as harshly processed and so have less damaged starch and protein.

More specifically, a processes for isolating legume protein may use one more of enyzmes, high g-force centrifugation, hydrocyclonic separation acids and basis. These remove most starch and fiber so that legume protein isolates have protein content from about 80% to 90%. But the process denatures the protein, so that legume protein isolates may denaturation enthalpy less than 1 J/g. In comparison the legume protein concentrates described in this specification have denaturation enthalpy greater than 3.75 J/g.

The higher denaturation enthalpy results from less harsh separation methods used to obtain legume protein concentrates. An illustrative process is air classification, which uses air counter currents to separate protein from starch in a base legume flour.

This specification discloses legume protein concentrates, preferably, pea protein concentrates, that are treated to remove unwanted flavors. In this specification, such pea protein concentrates are called de-flavored pea protein concentrates. Advantageously, the de-flavored pea protein concentrates described in this specification are processed to have little protein damage, for example with reference to the denaturation enthalpy of de-flavored pea protein concentrate or the percent change in denaturation enthalpy compared to a base pea protein concentrate. Also disclosed in this specification are processes for making the de-flavored pea protein concentrates and uses for the obtained de-flavored pea protein concentrates.

The technology disclosed in this specification can be better understood with reference to the following FIGURES, which are provided for illustrative purposes and are not intended to limit the full scope of the disclosed technology.

### BRIEF DESCRIPTION OF THE FIGURES

FIG. 1 graphs the flavor profile, as measured by an expert panel, of embodiments of de-flavored pea protein concentrates compared to a base pea protein concentrate.

In one aspect the technology disclosed in this specification pertains to a de-flavored legume protein concentrate. In preferred embodiments this specification discloses a de-flavored pea protein concentrate. In any embodiment described in this specification a de-flavored pea protein concentrate is a powdered composition obtain from peas having protein content greater than the base pea. Commonly peas have protein content from about 20% to about 30% according de-flavored pea protein concentrates have protein content greater from about 30% to about 35%, or to about 40%, or to about 45%, or to bout 45%, or to about 50% or to about 55%, or two about 60%, or to about 65%, or two about 70% or to about 75% and have a the pea protein has a denaturation enthalpy of at least about 3.75 J/g. In other embodiment this specification describes a de-flavored pea protein concentrate having a pea protein content from about 50% to about 70% (wt. % of the concentrate) or to about 67% or to about 62%, or from about 53% to about 70%, or to about 67% or to about 62%; and a protein denaturation enthalpy from about 3.75 to about 5.0 J/g, or from about 4.0 to about 5.0, or to about 4.75 or to about 4.5, or to about 4.3. In some preferred embodiments a pea protein concentrate having a denaturation enthalpy as described in this paragraph, has protein content from about 53% to about 57%. In another preferred embodiments a pea protein concentrate having denaturation enthalpy as described in this paragraph has protein content from about 57% to about 63%. In still another preferred embodiments a pea protein concentrate having denaturation enthalpy as described in this paragraph has protein content from about 63% to about 67%.

In any embodiment the de-flavored pea protein concentrate described in this specification further has a percent change in denaturation enthalpy compared to a base pea protein concentrated, from about 15% to about 25%, or to about 23%, or from about 17% to about 25% or about 23%. In at least some embodiments described in this specification wherein the de-flavored and base pea protein concentrates have a protein content of from about 53 to about 63%, or from about 53% to about 57%. (wt. %).

In any embodiment described in this specification, a de-flavored pea protein concentrate has a particle size distribution having a D50 from about 10 or from about 15 to about 35 microns, or from a range selected from the group consisting of from about 25, or from about 27 microns to about 35 or to about 33 or to about 31 microns; and from about 15 or from about 17 or from about 20 microns to about 25, or to about 23 microns.

In any embodiment described in this specification, a de-flavored pea protein concentrate has a particle size distribution having a D90 or from about 45 or from about 50 or from about 60, or from 70 or from 80, or from 90, or from about 100, or from about 115 or from about 120 microns to about 150, or to about 145, or to about 140, or to about 137 microns.

In any embodiment described in this specification, a de-flavored pea protein concentrate has a particle size distribution having D10 of from about 2 or from about 3 to about 7 or about 6 microns.

In any embodiment described in this specification, a de-flavored pea protein concentrate has a particle size distribution wherein the percent of particles that pass through a 100-mesh (149 micron) sieve is at least about 90% or at least about 95%.

In any embodiment described in this specification, a de-flavored pea protein concentrate has a percent soluble protein of from about 50% or from about 52% to about 60%, or to about 57%, or to about 55% (w/w).

In any embodiment described in this specification, a de-flavored pea protein concentrate has reduced bitterness compared to a base pea protein concentrate.

In any embodiment described in this specification, a de-flavored pea protein concentrate is not enzymatically or chemically modified.

In another aspect, this specification discloses methods for making a de-flavored pea protein concentrate. In broadest terms the process applies an aqueous fluid to a base pea protein concentrate to obtain a moistened pea protein concentrate; heats the moistened pea protein concentrate to obtain to obtain a heat-treated pea protein concentrate; and mills the heat-treated pea protein concentrate to obtain a de-flavored pea protein concentrate having a defined particle size distribution. A complete process may also upstream steps from the from de-flavoring processor other intermediate steps between heating and milling to obtain the final product. The upstream processes include steps to obtain a base pea protein concentrate whether starting from whole pea, partial peas, or pea flour. Intermediate steps may include processes to further dry a heat-treated protein concentrate.

Starting from whole or partial peas, these are ground or milled to obtain a pea flour. In this specification pea flour refers to a powdered composition suitable for making a base pea flour that is obtained by grinding or milling a pea or any part of pea or other similar process. Within this specification pea flour includes compositions having particle sizes that may more commonly be thought of as pea meal or pea grits. Pea flour can be obtained by any suitable method such as grinding or milling, including wet milling, dry milling, and pea flour has substantially the same pea protein content as the pea.

A base pea protein concentrate has a protein content as described in this specification, which is a protein content higher than occurs in peas. To obtain the increase protein content, any process can be used to that will produce a base pea protein concentrate having the characteristics described in this specification (notable lack of protein denaturation). A useful method for classifying and separating components of a pea flour to obtain a base pea protein concentrate is air classification. Air classification uses air current as a countervailing force to separate parts of a pea flour. For example, an air classifier may use air currents and a rotating mechanism to generate a centripetal fore on the flour. In operation, starch and protein generally have different weight and size and so experience drag and centripetal differently force. These differences can be used separate the protein from other parts of the flour. Air classifiers are known and available for example from Hosokawa-Alpine. An air classification process obtains a high protein, low starch portion called in this specification the base pea protein concentrate. The classification process also produces a low protein, high starch portion which can be used for other purposes.

Following air classification of the pea flour to obtain a base pea protein concentrate, the base pea protein concentrate is heat-treated in a process that use heat and moisture to de-flavor the pea protein concentrate. Moisture is applied to the base pea protein concentrate as one or more of aqueous steam, liquid water or aqueous solution. This reaction increases moisture content of the base pea protein concentrate above its ambient moisture content, commonly from about 8% to about 12% (wt. % moisture content). The additions of one or more of aqueous steam, and liquid water or aqueous solution is not intended to create a slurry, meaning that preferably, for any embodiment disclosed in this specification, the protein concentrate is able to absorb all liquid added to the system so that the system remains a single-phase systems (i.e. there is only a protein concentrate phase; there is no free liquid phase). Generally, legume protein concentrate can have a moisture content of from about 50% to about 60% (wt. % moisture) before a liquid phase forms.

With regard to an apparatus suitable for de-flavoring a pea protein concentrate, de-flavored pea protein concentrates described in this specification can be made in one or more reactors useful for applying one or more of aqueous steam, liquid water or aqueous solution to form a mixture and heating the mixture. A useful reactor is a fluidizing bed reactor, an illustrative embodiment of which is described in U.S. Pat. No. 5,378,434. Fluidized bed reactors generally comprise a hollow reactor vessel with one or more ports, at least some being at the bottom of the vessel, through which air or other gas is pumped to disperse (fluidize) a powder placed within the chamber of the reactor. Among the gases that can be injected into a fluidizing bed reactor is steam. Pea protein concentrates can be moistened by injection of steam alone (the pea protein concentrate being loaded into the reactor at ambient moisture) or can be pre-moistened prior to being loaded into the reactor. With reference to the methods for de-flavoring pea protein concentrate described in this specification, air flow and steam flow in the reactor apply moisture to base pea protein concentrate. The reactor wall can be heated, and heated gas can be used to heat the moistened pea protein concentrates as described in this specification. Also, the moisture content of the gas in the fluidizing bed reactor can be adjusted to dry the de-flavored pea protein.

Another useful reactor is a hollow tube reactor, an illustrative embodiment of which is described in EP0710670. Other hollow-tube type reactors useful for carrying out the methods for de-flavoring pea protein concentrate described in this specification include but are not limited to CoriMix® reactors (Lodige Process Technologies) and Horizontal Plow Mixers (B&P Littleford), and other reactors of this type. Generally a hollow-tube reactor comprises hollow-tube through which material may pass, inlet ports or other means for introducing solid materials like, base pea protein concentrate, and a fluids, like air or aqueous steam or liquid water or aqueous solution, into the hollow tube of the reactor so that the fluid is applied to the material passing through the reactor. Hollow-tube reactors also comprise a rotor, which is commonly screw shaped or comprises a radially projecting elements (like a fan). In operation the rotor pushes the material forward to an outlet port and may press material against the inner wall of the hollow tube as the material is pushed from an inlet port to an outlet port. In the methods for de-flavoring pea protein concentrate described in this specification the inner wall of the hollow tube is heated to the temperatures described in order to heat the moistened pea protein concentrate as it is pushed through the length of the hollow tube.

In at least some embodiments of the methods described in this specification, one or more of aqueous steam, and liquid water or aqueous solution are applied to the base pea protein concentrate to form a moistened pea protein concentrate that is heated in a first hollow-tube reactor to form a de-flavored pea protein concentrate that is dried in a second hollow-tube reactor. Steam and liquid are applied from different ports into the reactor but may be applied concurrently or sequentially in either order (steam or liquid) to obtain the moistened pea protein concentrate Also applying moisture and heating of the base pea protein concentrate can happen sequentially or concurrently, and in preferred embodiments are moistened and heated substantially concurrently by moistening a feed stock of base pea protein concentrated in a heated reactor.

Following heating, the heat-treated pea protein concentrate may be further dried using a fluid bed reactor or hollow tube reactor to a moisture content close to the equilibrium moisture of pea protein concentrate for example between about 4 and 15% (wt. %). Once dried to the desired moisture content the heat-treated pea protein concentrate is again milled to obtain a desired particle size. Second milling is useful to break-up aggregates of protein or protein and starch formed during the heat treatment. Also the second milling effects flavor intensive of the de-flavored pea protein concentrate. In preferred embodiments heat-treated pea protein concentrate is milled using an air classifying mill. This may of the type of apparatus used to air classify the pea flour, although it need not and more often will not be the same instance of the apparatus type-even of the same kind the pea flour and heat-treated pea protein concentrate will be air classified in different classifiers.

In at least some embodiments an air classifying mill, mills, classifies, and separates particles in the in the heat-treated pea protein concentrate—i.e. it will break down aggregates, and segregate aggregates of generally unwanted size from particles within a desired particle size distribution. Air classifying mills are available from Hosokawa-Alpine. Within an air classifying mill air classification occurs as described. Milling is done by some grinding apparatus through which a fluidized stream of heat-treated pea protein concentrate must pass. The grinding apparatus may a set of teeth on a rotating platform or other perforated solid structure that can break down aggregate particles within the fluidized stream as particles collide with solid structures. Once through the mill the fluidizing air stream pushes the particles to a separator which is a rotating structure having chambers to collect and carry particles of a desired size to an end repository. In practice particle size can be controlled for in an air classifying mill by varying one or more of the fluidizing air stream, the rotational speed of the mill and the rotation speed of a separator.

Description of specific operating parameters of reactors to make a de-flavored pea protein concentrate are disclosed. In any embodiment, this specification described a method for making a de-flavored pea protein concentrate comprising: applying an aqueous fluid to a pea protein concentrate to obtain a moistened pea protein concentrate; heating the moistened pea protein concentrate at a temperature from about 140° C., or from about 150° C., or from about 160° C., or from about 175° or to about 200° C., or to about 190° or two about 185° C. to obtain to obtain a heat-treated pea protein concentrate; and milling the heat-treated pea protein concentrate to obtain the de-flavored pea protein concentrate.

In any embodiment described in this specification, a method for making a de-flavored pea protein concentrate uses a classifying mill to separate at least a part of the heat-treated pea protein concentrate, wherein preferably the classifying mill is an air classifying mill.

In any embodiment described in this specification, a method for making a de-flavored pea protein concentrate uses a classifying mill that separates at least a part of the heat-treated pea protein concentrate to obtain the de-flavored pea protein concentrate wherein the obtained de-flavored pea protein concentrate has a particle size distribution having a D50 or from about 12, to about 35 microns, or from a range selected from the group consisting of from about 25, or from about 27 microns to about 35 or to about 33 or to about 31 microns; and or from 12, or from about 15 or from about 17 or from about 20 microns to about 25, or to about 23 microns.

In any embodiment described in this specification, a method for making a de-flavored pea protein concentrate uses an air classifying mill to separate at least part of the heat-treated pea protein concentrate by varying one or more of a fluidizing air speed, mill rotation speed, and separator rotation speed to obtain the de-flavored pea protein concentrate wherein the obtained de-flavored pea protein concentrate has a particle size distribution having a D50 or from about 12, or from about 15 to about 35 microns, or from a range selected from the group consisting of from about 25, or from about 27 microns to about 35 or to about 33 or to about 31 microns; and from about 12, or from about 15 or from about 17 or from about 20 microns to about 25, or to about 23 microns.

In any embodiment described in this specification, a method for making a de-flavored pea protein concentrate uses an air classifying mill capable of separating at least a part of the heat-treated pea protein concentrate using separator having variable rotational speed and separating at least a portion of the heat-treated pea protein concentrate using a rotational speed of from about 1000 or about 1050 or about 1100 or from about 1125 RPM to about 1200 RPM, or to about 1175 RPM.

In any embodiment described in this specification, a method for making a de-flavored pea protein concentrate uses an air classifying mill comprising one or more of a separator, to obtain the de-flavored pea protein concentrate wherein the de-flavored pea protein concentrate has a particle size distribution having a D50 from about 15 to about 35 microns, or from a range selected from the group consisting of from about 25, or from about 27 microns to about 35 or to about 33 or to about 31 microns; and from about 15 or from about 17 or from about 20 microns to about 25, or to about 23 microns.

In any embodiment described in this specification a de-flavored pea protein concentrate is made by applying moisture a base pea protein concentrate and heating moistened pea protein concentrate in a hollow tube reactor or a fluidized bed reactor.

In any embodiment described in this specification a de-flavored pea protein concentrate is made by heating a moistened pea protein concentrate a time from about 1 to 2 minutes to obtain the heat-treated pea protein concentrate.

In any embodiment described in this specification a de-flavored pea protein concentrate is made by the applying one or more of an aqueous steam, liquid water, or aqueous solution optionally, wherein, the applying step comprises applying aqueous steam and liquid water; optionally wherein the liquid water or aqueous solution, preferably liquid water, is applied to the pea protein concentrate in ratio (concentrate to water) of from about 4.0:1 to about 6.0:1, or to about 5.7:1 or to about 5.5:1 or to about 5.3:1, or to about 5.0:1, or to 4.7:1, or to about 4.5 to 1 or to about 4.3:1 and optionally, wherein, the aqueous steam is applied to the base pea protein concentrate in a ratio (concentrate to steam) of from about 10:1 or about 10.5:1 to about 12:1, or about 11.5:1.

In any embodiment described in this specification a de-flavored pea protein concentrate is made by drying the heat-treated pea protein concentrate to a moisture content from about 4% to about 15% (wt. %) with an air flow having a temperature from about 140° C. to about 160° C., or from about 145° C. to about 155° C.

In any embodiment described in this specification a de-flavored pea protein concentrate is made by applying moisture to a base pea protein concentrate and by heating a moisten pea protein concentrate in a hollow tube of a hollow tube reactor, the reactor further comprising a rotor within the hollow tube of the hollow-tube reactor; and wherein the rotor is rotated at a rate or from about 400, or from about 450, or from about 500 RPM, or from about 550, or about from about 600 or from about 650 or from about 700 or from about 750 to about 900 or to about 850, or from about 550 to about 900, or to about 850, or to about 800, or to about 750 or to about 700 or to about 650; preferably, wherein the rotor is rotated from about 500 to about 600 RPM or from about 550 to about 650 RPM, more preferably, wherein the rotor is rotated from about or less than about 700 to about 900 RPM or from about 750 to about 850 RPM.

In any embodiment described in this specification a de-flavored pea protein concentrate is made by drying the de-flavored pea protein concentrate in a hollow tube of a hollow-tube reactor, the reactor comprising a rotor within the hollow tube of the hollow-tube reactor; and wherein the rotor is rotated at a rate of from about 300 to about 500 RPM or from about 350 to about 450 RPM optionally, wherein, the de-flavored pea protein concentrate is dried to a moisture content from about 4% to about 15% (wt. %) in a hollow tube of a hollow-tube reactor, the reactor further comprising a rotor within the hollow tube of the hollow-tube reactor: wherein the drying is done at least in part by passing air having a temperature from about 140° C. to about 160° C., or from about 145° C. to about 155° C. through the hollow tuber of the reactor; and wherein the rotor is rotated at a rate of from about 300 to about 500 RPM or from about 350 to about 450 RPM.

In any embodiment described in this specification a de-flavored pea protein concentrate is made by applying moisture to a base pea protein concentrate and heating a moistened pea protein concentrate in a first hollow-tube reactor and drying a de-flavored pea protein concentrate in a second hollow-tube reactor.

In any embodiment described in this specification a de-flavored pea protein concentrate is made by separating at least part of a protein from a pea flour to obtain the base pea protein concentrate.

In any embodiment described in this specification a de-flavored pea protein concentrate is made by providing a pea flour comprising a pea protein and separating part of the pea protein from the base pea flour using a process that does not denature the protein in the flour.

In any embodiment described in this specification a de-flavored pea protein concentrate is made by providing a pea flour comprising a pea protein and separating part of the pea protein from the base pea flour using an air classifying process.

In any embodiment described in this specification a de-flavored pea protein concentrate the liquid water or aqueous solution or aqueous steam do not comprise an enzyme or chemical that that enzymatically or chemically modifies the de-flavored legume flour.

Also described are de-flavored pea protein concentrates made by any process described in this specification.

The de-flavored pea protein concentrates described are used as other protein concentrate and other pea protein concentrates are used. In any embodiment described in this specification, a de-flavored pea protein concentrate as is used food composition. The pea protein concentrates useful in food compositions in an amount from 1% to 99% wt. % of the food composition. The disclosed pea protein concentrates are useful to replace can be used to replace animal protein or replace gluten containing protein concentrates or to provide fortification relative cereal protein concentrates. Illustrative food compositions include gravies, sauces, particularly vegan white sauces or cheese sauces, soups, puddings, salad dressings, analog yogurts, analog sour creams, custards, analog cheese products, baked goods including pastries and dough based baked goods like pie crusts, cookies, breads, crackers, or batter based baked goods like cakes, and muffins.

In at least some embodiments a de-flavored pea protein concentrate, as described in this specification, is used in a baked good to reduce the usage of a cereal protein concentrate in whole or in part. In at least some embodiments of the de-flavored pea protein concentrate is used in a gluten free baked good.

The de-flavored pea protein concentrates have been observed, advantageously, to reduce the hardness of a baked good relative to the same baked good using a base pea protein concentrate.

In any embodiment this specification describes methods for making a food composition comprises adding a de-flavored pea protein concentrate and a second ingredient. With reference to compositions that are edible ingredients, second ingredients can be any edible ingredient, including but not limited to aqueous or lipid-based ingredients, fats, oils, other starches (including native, gelatinized, and modified starches), protein isolates or concentrates, protein concentrate, hydrocolloids or gelling agents, flavorings, coloring, sweeteners, and dairy ingredients.

With reference to specific certain food composition (particularly baked goods) the composition may comprising a wheat flour used in a ratio (de-flavored legume flour to wheat flour) of from about 1:1 to about 1:5, or from about 1:2 to about 1:5, or from 1:3, to 1:5. In any embodiment of a food composition described in this specification a baked good, has a flour component that consists of all the flour within the baked good, wherein the flour component comprises de-flavored legume flour in an amount of at least about 10%, or at least about 20%, or at least about 30%, or at least about 40%, or at least about 50%. Also, in any embodiment of a food composition described in this specification a baked good comprise a flour component that consists of all of the flour within the bake good, and wherein the flour component consists of de-flavored legume flour and wheat flour and wherein the de-flavored legume flour is used in the flour component in an amount from about 10% to about 50%, or to about 40%, or to about 30%, or to about 25% (wt. %), or from about 15% to about 50%, or to about 40%, or to about 30%, or to about 25% (wt. %).

De-flavored pea protein concentrates are useful in oil-in-water emulsions, where the de-flavored pea protein concentrate acts as an emulsifier. Emulsions may be savory or sweet and include ice creams, sauces, dressings, gravies. De-flavored pea protein concentrates may be used in an oil-in-water emulsion, having oil content of greater than about 25%, or greater than about 45%, or greater than about 70%, or from about 25%, to about 80%, or from about 25% to about 55%, or from about 55% to about 80%. In any embodiment of food composition described in this specification an oi-in-water emulsion comprises a de-flavored pea protein concentrate in an amount from about 0.1, or from about 0.25% or from about 0.45%, or from about 0.65% to about 5%, or to about 4%, or to about 3%, or to about 2%, or to about 1.75%, or to about 1.65%, or to about 1.55%, or to about 1.45% or to about 1.35%, or to about 1.25%, or to about 1.15%, or to about 1.05%.

The process disclosed in this specification to make de-flavored pea protein concentrates and the uses of de-flavored pea protein concentrates described in this specification are applicable to other.

Use of “about” to modify a number is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

The technology described in this specification can be further understood with reference to the following non-limiting aspects, which are provided for illustrative purposes and are not intended to limit the full scope of the invention.

1. A de-flavored pea protein concentrate having a pea protein content selected from a range within the group consisting of a. from about 30% (wt. % of the concentrate) to about 35%, or to about 40%, or to about 45%, or to about 45%, or to about 50% or to about 55%, or two about 60%, or to about 65%, or two about 70% or to about 75%; and b. from about 50% to about 70% (wt. % of the concentrate) or to about 67% or to about 62%, or from about 53% to about 70%, or to about 67% or to about 62% and a protein denaturation enthalpy from about 3.75 to about 5.0 J/g, or from about 4.0 to about 5.0, or to about 4.75 or to about 4.5, or to about 4.3; optionally, wherein the pea protein concentrate has pea protein range selected from the group consisting of: i. from about 53 to about 57%; ii. from about 57% to about 63%; and from about 63% to about 67%.

2. The de-flavored pea protein concentrate of claim 1 further having a percent change in denaturation enthalpy compared to a base pea protein concentrated, from about 15% to about 25%, or to about 23%, or from about 17% to about 25% or about 23%. optionally, wherein the de-flavored and base pea protein concentrates have a protein content of from about 53 to about 63% (wt. %), or from about 53% to about 57%.

3. The de-flavored pea protein concentrate of claims 1 and 2 having a particle size distribution having a D50 from about 10 to about 35 microns, or from a range selected from the group consisting of a. from about 25, or from about 27 microns to about 35 or to about 33 or to about 31 microns; and b. from about 10, or from about 12, or from about 15 or from about 17 or from about 20 microns to about 25, or to about 23 microns.

4. The de-flavored pea protein concentrate of any one of claims 1 and 3 having a particle size distribution having a D90 or from about 45 or from about 50 or from about 60, or from 70 or from 80, or from 90, or from about 100, or from about 115 or from about 120 microns to about 150, or to about 145, or to about 140, or to about 137 microns.

5. The de-flavored pea protein concentrate of any one of claims 1 to 4 having a particle size distribution having D10 of from about 2 or from about 3 to about 7 or about 6 microns.

6. The de-flavored pea protein concentrate of any one of claims 1 to 5 having a particle size distribution wherein the percent of particles that pass through a 100-mesh (149 micron) sieve is at least about 90% or at least about 95%.

7. The de-flavored pea protein concentrate of any one of claims 1 to 6 having a percent soluble pea protein from about 50% or from about 52% to about 60%, or to about 57%, or to about 55% (w/w).

8. The de-flavored pea protein concentrate of any one of claims 1 to 7 having reduced bitterness compared to a base pea protein concentrate.

9. The de-flavored pea protein concentrate of any one of claims 1 to 8 that is not enzymatically or chemically modified.

10. A method for making a de-flavored legume protein concentrate comprising: a. applying an aqueous fluid to a base pea protein concentrate to obtain a moistened pea protein concentrate; b. heating the moistened legume flour at a temperature 140° C., or from about 150° C., or from about, or from about 160° C., or from about 175° or to about 200° C., or to about 190° or two about 185° C. to obtain to obtain a heat-treated pea protein concentrate; c. and milling the heat-treated pea protein concentrate to obtain the de-flavored pea protein concentrate; preferably, wherein the de-flavored legume protein concentrate is a de-flavored pea protein concentrate.

11. The method of claim 10 wherein the milling uses a classifying mill to separate at least a part of the heat-treated pea protein concentrate, wherein preferably the classifying mill is an air classifying mill.

12. The method of any one of claim 10 or 11 wherein the milling uses a classifying mill that separates at least a part of the heat-treated pea protein concentrate to obtain the de-flavored pea protein concentrate wherein the obtained de-flavored pea protein concentrate has a particle size distribution having a D50 from about 10 to about 35 microns, or from a range selected from the group consisting of a. from about 25, or from about 27 microns to about 35 or to about 33 or to about 31 microns; and b. from about 10 or, or from about 12, or from about 15 or from about 17 or from about 20 microns to about 25, or to about 23 microns.

13. The method of any one of claims 10 to 12 wherein the milling uses an air classifying mill to separate at least part of the heat-treated pea protein concentrate by varying one or more of the air flow speed, rotor speed, and separator speed to obtain the de-flavored pea protein concentrate wherein the obtained de-flavored pea protein concentrate has a particle size distribution having a D50 from about 15 to about 35 microns, or from a range selected from the group consisting of a. from about 25, or from about 27 microns to about 35 or to about 33 or to about 31 microns; and b. from about 15 or from about 17 or from about 20 microns to about 25, or to about 23 microns.

14. The method of claims 10 to 13 wherein the milling uses an air classifying mill capable of separating at least a part of the heat-treated pea protein concentrate using separator having variable rotational speed and separating at least a portion of the heat-treated pea protein concentrate using a rotational speed of from about 1000 or about 1050 or about 1100 or from about 1125 RPM to about 1200 RPM, or to about 1175 RPM.

15. The method of any one of claims 10 to 14 wherein the milling uses an air classifying mill comprising one or more of a separator, to obtain the de-flavored pea protein concentrate wherein the de-flavored pea protein concentrate has a particle size distribution having a D50 from about 15 to about 35 microns, or from a range selected from the group consisting of a. from about 25, or from about 27 microns to about 35 or to about 33 or to about 31 microns; and b. from about 15 or from about 17 or from about 20 microns to about 25, or to about 23 microns.

16. The method of any one of claims 10 to 15 wherein the applying and heating steps take place in a hollow tube reactor or a fluidized bed reactor.

17. The method of any one of claims 10 to 16 wherein the heating is for a time from about 1 to 2 minutes to obtain the heat-treated pea protein concentrate.

18. The method of claims 10 to 17 wherein the applying step comprises applying one or more of an aqueous steam, liquid water, or aqueous solution optionally, wherein, the applying step comprises applying aqueous steam and liquid water; optionally wherein the liquid water or aqueous solution, preferably liquid water, is applied to the base pea protein concentrate in ratio (concentrate to water) of from about 4.0:1 to about 6.0:1, or to about 5.7:1 or to about 5.5:1 or to about 5.3:1, or to about 5.0:1, or to 4.7:1, or to about 4.5 to 1 or to about 4.3:1.

optionally, wherein, the aqueous steam is applied to the base pea protein concentrate in a ratio (concentrate to water) of from about 10:1 or about 10.5:1 to about 12:1, or about 11.5:1.

19. The method of any one of claims 10 to 18 further comprising drying the heat-treated pea protein concentrate to a moisture content from about 4% to about 15% (wt. %) with an air flow having a temperature from about 140° C. to about 160° C., or from about 145° C. to about 155° C.

20. The method of any one of claims 10 to 19 wherein the applying step and heating step occur in a hollow tube of a hollow tube reactor, the reactor further comprising a rotor within the hollow tube of the hollow-tube reactor; and wherein the rotor is rotated at a rate from about 400, or from about 450, or from about 500 RPM, or from about 550, or about from about 600 or from about 650 or from about 700 or from about 750 to about 900 or to about 850, or from about 550 to about 900, or to about 850, or to about 800, or to about 750 or to about 700 or to about 650; preferably, wherein the rotor is rotated from about 500 to about 600 RPM or from about 550 to about 650 RPM, more preferably, wherein the rotor is rotated from about or less than about 700 to about 900 RPM or from about 750 to about 850 RPM.

21. The method of any one of claims 10 to 20 further comprising drying the de-flavored pea protein concentrate in a hollow tube of a hollow-tube reactor, the reactor comprising a rotor within the hollow tube of the hollow-tube reactor; and wherein the rotor is rotated at a rate of from about 300 to about 500 RPM or from about 350 to about 450 RPM optionally, wherein, the de-flavored pea protein concentrate is dried to a moisture content from about 4% to about 15% (wt. %) in a hollow tube of a hollow-tube reactor, the reactor further comprising a rotor within the hollow tube of the hollow-tube reactor: wherein the drying is done at least in part by passing air having a temperature from about 140° C. to about 160° C., or from about 145° C. to about 155° C. through the hollow tuber of the reactor; and wherein the rotor is rotated at a rate of from about 300 to about 500 RPM or from about 350 to about 450 RPM.

22. The method of any one of claims 10 to 21 wherein the applying step and heating step are done in a first hollow-tube reactor and the de-flavored pea protein concentrate is dried in a second hollow-tube reactor.

23. The method of any one of claims 10 to 22 further comprising, prior to step a) separating at least part of a protein from a base pea flour to obtain the base pea protein concentrate.

24. The method of any one of claims 10 to 23 further comprising, prior to step a) providing a base pea flour comprising a pea protein and separating part of the pea protein from the base pea flour using a process that does not denature the protein in the flour.

25. The method of any one of claims 10 to 24 further comprising, prior to step a) providing a base pea flour comprising a pea protein and separating part of the pea protein from the base pea flour using an air classifying process.

26. The method of any one of claims 10 to 25 wherein the liquid water or aqueous solution or aqueous steam do not comprise an enzyme or chemical that that enzymatically or chemically modifies the de-flavored legume flour.

27. A de-flavored pea protein concentrate as described in any one of claims 1 to 9 according to a process a described in any one claims 10 to 25.

28. Use of a de-flavored pea protein concentrate as described in any foregoing claim a food composition.

29. Use of a de-flavored pea protein concentrate as described in claim 28 to replace at least part of a cereal flour in a baked good, optionally, wherein the de-flavored pulse protein concentrate replaces the cereal flour on a one-for-one basis (w/w).

30. Use of a de-flavored pea protein concentrate as described in claim 28 or 29 in a gluten free baked good.

31. Use of a de-flavored pea protein concentrate as described in any one of claims 28 to 30 in an oil-in-water emulsion, wherein the emulsion has an oil content of greater than about 25%, or greater than about 45%, or greater than about 70%, or from about 25%, to about 80%, or from about 25% to about 55%, or from about 55% to about 80%.

32. A food composition comprising a de-flavored pea protein concentrate as described in any foregoing claim and an edible ingredient.

33. The food composition of claim 32 wherein the composition is a food composition, or a gluten free food composition.

34. The food composition of claims 32 to 33 further comprising a wheat flour used in a ratio (de-flavored legume flour to wheat flour) of from about 1:1 to about 1:5, or from about 1:2 to about 1:5, or from 1:3, to 1:5.

35. The food composition of any one of claims 32 to 34 being a baked good, which has a flour component that consists of all the flour within the baked good, and wherein the flour component comprises de-flavored legume flour in an amount of at least about 10%, or at least about 20%, or at least about 30%, or at least about 40%, or at least about 50%.

36. The food composition of any one of claims 32 to 35 being a baked good comprising a flour component that consists of all of the flour within the bake good, and wherein the flour component consists of de-flavored legume flour and wheat flour and wherein the de-flavored legume flour is used in the flour component in an amount from about 10% to about 50%, or to about 40%, or to about 30%, or to about 25% (wt. %), or from about 15% to about 50%, or to about 40%, or to about 30%, or to about 25% (wt. %).

37. The food composition of any one of claims 32 to 36 being a gluten free.

38. The food composition of any one of claims 32 to 37 being an oil in water emulsion comprising: a. an oil content of greater than about 25%, or greater than about 45%, or greater than about 70%, or from about 25%, to about 80%, or from about 25% to about 55%, or from about 55% to about 80%; and b. de-flavored pea protein concentrate as described in any foregoing claim in an amount from about 0.1, or from about 0.25% or from about 0.45%, or from about 0.65% to about 5%, or to about 4%, or to about 3%, or to about 2%, or to about 1.75%, or to about 1.65%, or to about 1.55%, or to about 1.45% or to about 1.35%, or to about 1.25%, or to about 1.15%, or to about 1.05%.

39. A de-flavored pea protein concentrate comprising:
a. a pea protein content in a range from about 30% to about 75% (wt. % of the concentrate) or from about 50% to about 70%, or from 50% to about 67%, or from about 53% to about 67%, or from about 57% to about 67%.
b. and a protein denaturation enthalpy from about 3.75 to about 5.0 J/g, or from about 4.0 to about 5.0, or to about 4.75 or to about 4.5, or to about 4.3;

40. The de-flavored pea protein concentrate of claim 39 further comprising a particle size distribution having a D50 from about 10 to about 35 microns, or in a range selected from the group consisting of:
a. from about 25 to about 35 microns, or from about 25 to about 33 microns, or from about 25 to about 31 microns, or from about 27 microns to about 35 or from about 27 microns to about 33 or to about 31 microns; and
b. from about 10 to about 25 or from about 15 to about 25, or from about 17 to about 25, or from about 20 to about 25 microns.

41. The de-flavored pea protein concentrate of claim 39 or 40 further comprising a particle size distribution having a D90 or from about 45 to about 150 microns, or from about 50 to about 150 microns or from about 60 to about 150 microns, or from 70 to about 150 microns, or from 80 to about 150 microns, or from 90 to about 150 microns, or from about 100 to about 150 microns, or from about 115 to about 150 microns or from about 120 microns to about 150, or from about 120 microns to about 145.

43. The de-flavored pea protein concentrate of any one of claims 39 to 42 further comprising a particle size distribution having D10 of from about 2 or to about 7.

44. The de-flavored pea protein concentrate of any one of claims 39 to 43 further comprising a particle size distribution wherein the percent of particles that pass through a 100-mesh (149 micron) sieve is at least about 90%, or at least about 95%.

45. The de-flavored pea protein concentrate of any one of claims 39 to 44 further having a percent soluble pea protein from about 50% to about 60% or from about 52% to about 57%, (w/w).

46. The de-flavored pea protein concentrate of any one of claims 39 to 45 that is not enzymatically or chemically modified.

47. The de-flavored pea protein concentrate of any one of claims 39 to 46 having a % reduction of at least 65% (measured using the GC/MS method provided in this specification) of at least one chemical present in an untreated pea protein concentrate wherein, optionally, chemical present in an untreated pea protein concentrated is at least one of acetaldehyde, propanal, 2-propanone, 2-butanone, ethanol, pentanal, benzene, methyl-hexanal, 1-penten-3-ol, 2-heptanone, furan, 2-pentyl-1-pentanol, octanal, 1-hexanol, nonanal, 3-octen-2-one, 2 octenal, acetic acid, 1-octen-3-ol, 1-heptanol, benzaldehyde, (e)-non-2 enal, 1-octanol, 3,5-octadien-2-one, 2-octen-1-ol, (e)-1-nonanol, butanoic acid, 3-methyl-butanoic acid, hexanoic acid.

48. The de-flavored pea protein concentrate of claims 39 to 47 having a % reduction of at least about 70% or at least about 80% (measured using the GC/MS method provided in this specification) of at least one chemical present in an untreated pea protein concentrate wherein, optionally, chemical present in an untreated pea protein concentrated is at least one of acetaldehyde, propanal, 2-propanone, ethanol, pentanal, benzene, methyl-hexanal, 1-penten-3-ol, 2-heptanone, furan, 2-pentyl-1-pentanol, octanal, 1-hexanol, nonanal, 3-octen-2-one, 2 octenal, acetic acid, 1-octen-3-ol, 1-heptanol, benzaldehyde, (e)-non-2 enal, 1-octanol, 3,5-octadien-2-one, 2-octen-1-ol, (e)-1-nonanol, hexanoic acid.

49. The de-flavored pea protein concentrate of any one of claims 39 to 48 having a % reduction of at least about 90% (measured using the GC/MS method provided in this specification) of at least one chemical present in an untreated pea protein concentrate wherein, optionally, chemical present in an untreated pea protein concentrated is at least one of propanal, ethanol, pentanal, methyl-hexanal, 1-penten-3-ol, 2-heptanone, furan, 2-pentyl-1-pentanol, octanal, 1-hexanol, nonanal, 3-octen-2-one, 2 octenal, acetic acid, 1-octen-3-ol, 1-heptanol, benzaldehyde, (e)-non-2 enal, 1-octanol, 3,5-octadien-2-one, (e)-1-nonanol, hexanoic acid.

50. The de-flavored pea protein concentrate of any one of claims 39 to 49 having a % reduction of at least about 95% (measured using the GC/MS method provided in this specification) of at least one chemical present in an untreated pea protein concentrate wherein, optionally, chemical present in an untreated pea protein concentrated is at least one of acetaldehyde, propanal, pentanal, methyl-hexanal, 1-penten-3-ol, 2-heptanone, furan, 2-pentyl-1-pentanol, octanal, 1-hexanol, 3-octen-2-one, 2 octenal, acetic acid, 1-octen-3-ol, 1-heptanol, benzaldehyde, (e)-non-2 enal, 1-octanol, 3,5-octadien-2-one, (e)-1-nonanol, hexanoic acid.

51. A method for making a de-flavored pea protein concentrate comprising:
a. applying an aqueous fluid to a base pea protein concentrate to obtain a moistened pea protein concentrate;
b. heating the moistened legume flour at a temperature 140° C., or from about 150° C., or from about, or from about 160° C., or from about 175° or to about 200° C., or to about 190° or two about 185° C. to obtain to obtain a heat-treated pea protein concentrate;
c. and milling the heat-treated pea protein concentrate to obtain the de-flavored pea protein concentrate;
wherein the applying step comprises applying an aqueous steam to the base pea protein concentrate in a ratio (concentrate to water) of from about 7:1 to about 12:1, or about 8:1 to about 12:1 or about 9:1 to about 12:1 or about 10:1 to 12;
optionally wherein applying step further comprises applying liquid water or aqueous solution, preferably liquid water, to the base pea protein concentrate in ratio (concentrate to water) of from about 4.0:1 to about 6.0:1, or about 4.0:1 to about 5.7:1, or from about 4.0:1 to about 5.5:1, or from about 4.0:1 to about 5.3:1, or from about 4:0.1 to about 5.0:1.

52. The method of claim 51 wherein the milling uses a classifying mill to separate at least a part of the heat-treated pea protein concentrate, wherein preferably the classifying mill is an air classifying mill.

53. The method of any one of claim 51 or 52 wherein the milling uses a classifying mill that separates at least a part of the heat-treated pea protein concentrate to obtain the de-flavored pea protein concentrate wherein the obtained de-flavored pea protein concentrate has a particle size distribution having a D50 from about 10 to about 35 microns, or in a range selected from the group consisting of:
a. from about 25 to about 35 microns, or from about 25 to about 33 microns, or from about 25 to about 31 microns, or from about 27 microns to about 35 or from about 27 microns to about 33 or to about 31 microns; and
b. from about 10 to about 25 or from about 15 to about 25, or from about 17 to about 25, or from about 20 to about 25 microns.

54. The method of any one of claims 51 to 53 wherein the milling uses an air classifying mill to separate at least part of the heat-treated pea protein concentrate by varying one or more of the air flow speed, rotor speed, and separator speed to obtain the de-flavored pea protein concentrate wherein the obtained de-flavored pea protein concentrate has a particle size distribution having a D50 from about 10 to about 35 microns, or in a range selected from the group consisting of:
a. from about 25 to about 35 microns, or from about 25 to about 33 microns, or from about 25 to about 31 microns, or from about 27 microns to about 35 or from about 27 microns to about 33 or to about 31 microns; and
b. from about 10 to about 25 or from about 15 to about 25, or from about 17 to about 25, or from about 20 to about 25 microns.

55. The method of any one of claims 51 to 54 wherein the milling uses an air classifying mill capable of separating at least a part of the heat-treated pea protein concentrate using separator having variable rotational speed and separating at least a portion of the heat-treated pea protein concentrate using a rotational speed of from about 1000 or from about 1050 or about 1100 or from about 1125 RPM to about 1200 RPM.

56. The method of any one of claims 51 to 55 wherein the applying and heating steps take place in a hollow tube reactor or a fluidized bed reactor.

57. The method of any one of claims 51 to 56 wherein the heating is for a time from about 1 to 2 minutes to obtain the heat-treated pea protein concentrate.

58. The method of any one of claims 51 to 57 further comprising drying the heat-treated pea protein concentrate to a moisture content from about 4% to about 15% (wt. %) with an air flow having a temperature from about 140° C. to about 160° C., or from about 145° C. to about 155° C.

59. The method of any one of claims 51 to 58 wherein the applying step and heating step occur in a hollow tube of a hollow tube reactor, the reactor further comprising a rotor within the hollow tube of the hollow-tube reactor; and wherein the rotor is rotated at a rate from about 400 to about 900; or in a range selected from the group consisting of:
a) wherein optionally, the rotor is rotated from about 500 to about 600 RPM or from about 550 to about 650 RPM,
b) more preferably, wherein the rotor is rotated from about 700 to about 900 RPM or from about 750 to about 850 RPM, and
c) from about 300 to about 500 RPM or from about 350 to about 450 RPM.

60. The method of any one of claims 51 to 59 wherein the applying step and heating step are done in a first hollow-tube reactor and the de-flavored pea protein concentrate is dried in a second hollow-tube reactor.

61. The method of any one of claims 51 to 60 further comprising, prior to step a) separating at least part of a protein from a base pea flour to obtain the base pea protein concentrate.

62. The method of any one of claims 51 to 61 further comprising, prior to step a) providing a base pea flour comprising a pea protein and separating part of the pea protein from the base pea flour using a process that does not denature the protein in the flour.

63. The method of any one of claims 51 to 62 further comprising, prior to step a) providing a base pea flour comprising a pea protein and separating part of the pea protein from the base pea flour using an air classifying process.

64. The method of any one of claims 51 to 63 wherein the liquid water or aqueous solution or aqueous steam do not comprise an enzyme or chemical that that enzymatically or chemically modifies the de-flavored legume flour.

65. A de-flavored pea protein concentrate as described in any one of claims 39 to 50 according to a process a described in any one of claims 51 to 64.

66. A food composition comprising a de-flavored pea protein concentrate as described in any foregoing claim and an edible ingredient.

67. The food composition of claim 66 being a baked good, which has a flour component that consists of all the flour within the baked good, and wherein the flour component comprises de-flavored legume flour in an amount of at least about 10%, or at least about 20%, or at least about 30%, or at least about 40%, or at least about 50%.

68. The food composition of claim 66 or 67 being an oil in water emulsion comprising:
a. an oil content of greater than about 25%, or greater than about 45%, or greater than about 70%, or from about 25%, to about 80%, or from about 25% to about 55%, or from about 55% to about 80%; and
b. de-flavored pea protein concentrate as described in any foregoing claim in an amount from about 0.1% to about 5%, or to about 3%, or to about 2%, or to about 1.75%, or to about 1.65%, or to about 1.55%, or to about 1.45% or to about 1.35%, or to about 1.25%, or to about 1.15%, or to about 1.05%.

The technology described in this specification can be further understood with reference to the following non-limiting examples, which are provided for illustrative purposes and are not intended to limit the full scope of the invention.

### Example 1—Processes for Making De-Flavored Pea Flour and De-Flavored Protein Concentrate

De-flavored pea protein concentrates were made from a base pea protein concentrate having about 55% protein content (wt. %). Base pea protein concentrates were obtained using air classification of base pea flours, that were obtained by a dry milling processes. The classified base pea protein concentrate was then de-flavored using a two-stage turbo reactor comprising thermal cooking reactor and drying reactor. Both stages of the reactor were jacketed hollow-tube reactors with inlets for receiving a liquid or a gas. The jacket heated the inner surface of the hollow-tube reactor. During processing raw pea flour or raw pea protein concentrate (moisture content about 10%) was fed into the cooking reactor along with steam and water (from separate inlets) to form a high moisture protein concentrate. The pea flour and pea protein concentrate passed through the reactor and were then dried in the drying reactor, which dried the pea flour or the pea protein concentrate using heat and warmed air.

Following de-flavoring the de-flavored pea protein concentrate is milled using a Hosokawa Air Classification Mill to break up agglomerates and control for particle size. The air classification mill has three separated mechanism for adjusting particle size, air flow speed, rotor speed, and separator speed. For all trials, air flow speed and rotor speed were fixed, but separator speed was varied to obtain material having different particle size. Generally, powder milled at faster separator speed is finer.

Various de-flavored pea protein concentrates were made by treating base pea protein concentrates using the processing conditions described in Table 1. Mill separator speed refers to the separate speed of the Hosokawa Air Classifying Mill and is applied after de-flavoring treatment. Feed rate refers to feed rate of the base pea protein concentrate. Water rate and steam rate refer to the rate of water or steam flow into the cooking reactor.

TABLE 1
Cook Reactor Processing Conditions for De-Flavored Pea Protein Concentrate

| | | Feed Rate | | | | Feed | | Feed |
|---|---|---|---|---|---|---|---|---|
| | Mill | or base pea | Cooking | Cooking | | Rate to | | rate to |
| | Separator | protein | reactor | reactor | Water | Water | Steam | steam |
| | Speed | concentrates | temperature | speed | Rate | Rate | Rate | rate |
| Batch | (RPM) | (kg/hr) | (wall) (° C. ) | (RPM) | (L/hr) | Ratio | (L/hr) | ratio |
| PC1320 | 1200 | 3300 | 180 | 400 | 800 | 4.1:1 | 300 | 11:1 |
| PC1230 | 1250 | 3300 | 180 | 500 | 600 | 5.5:1 | 300 | 11:1 |
| PC1140 | 1300 | 3300 | 160 | 500 | 600 | 5.5:1 | 300 | 11:1 |
| PC1210 | 1150 | 3300 | 160 | 500 | 800 | 5.5:1 | 300 | 11:1 |
| PC1100 | 1200 | 3300 | 180 | 400 | 600 | 5.5:1 | 300 | 11:1 |
| PC0935 | 1300 | 3300 | 160 | 400 | 600 | 5.5:1 | 300 | 11:1 |
| PC1020 | 1250 | 3300 | 160 | 400 | 800 | 4.1:1 | 300 | 11:1 |
| PC1125 | 1050 | 3300 | 160 | 500 | 800 | 4.1:1 | 300 | 11:1 |
| PC1000 | 1050 | 3300 | 180 | 400 | 800 | 4.1:1 | 300 | 11:1 |

De-flavored pea protein concentrates were made using the processes described in Table 1 were evaluated for flavor as describe in Example 2 and for protein damage as described in Example 3.

All samples of de-flavored pea protein concentrates were dried in the drying reactor under the same conditions, which are listed in Table 2.

TABLE 2
Drying Reactor Process Conditions

| Dryer | Dryer Oil Inlet | Air | Air Fan |
|---|---|---|---|
| speed | Temperature | Temperature | Speed |
| (RPM) | (° C.) | (° C.) | (%) |
| 400 rpm | 180 | 150 | 60 |

### Example 2—Sensory Evaluation of Pulse Protein Concentrate

De-flavored pea protein concentrate samples were blended with spring water to create 6.6% solutions, accounting for moisture. All samples were evaluated by a highly trained external panel for 7 flavor and texture attributes. Samples were prepared on the day of evaluation and assessed at ambient temperature (˜70° F.). Intensities were rated using a 15-point Universal Scale. Analysis of Variance (ANOVA) and Tukey's post-hoc multiple comparison test was applied to the data to assess statistical significance. (See e.g. (See e.g. Meilgaard, M. C. et al., Sensory Evaluation Techniques, Fourth Edition, CRC Press (2007) (ISBN: 0-8493-3839-5) at pp. 189-254).

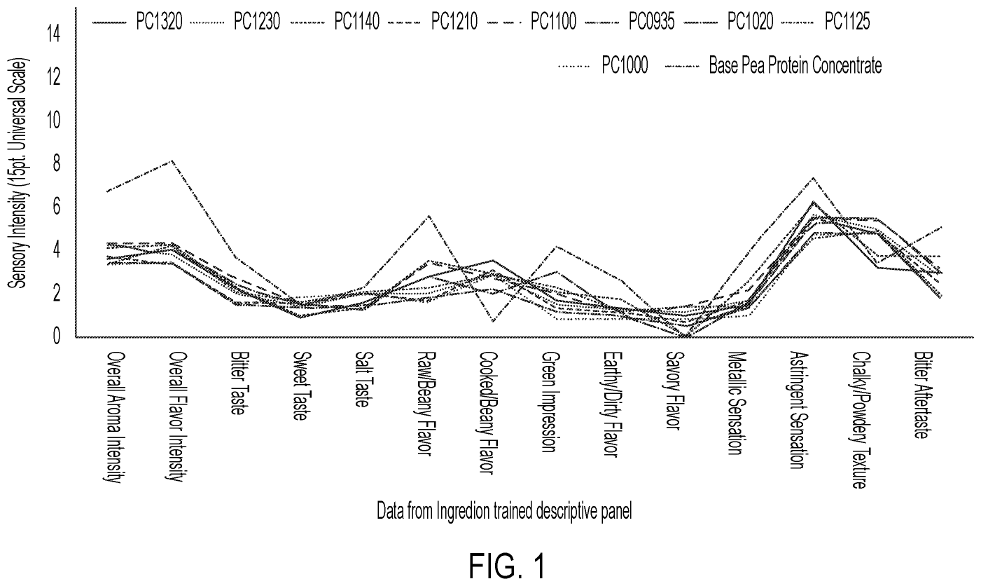

Results for de-flavored pea protein concentrate are graphed in FIG. 1. Flavor intensity is on the vertical axis with 0 meaning a flavor attribute was least intense (or not perceived) and 15 meant a flavor attribute was most intense. Flavor attributes are on horizontal axis.

With reference to FIG. 1, all de-flavored pea protein concentrate samples had less intense flavor profiles than the base pea protein concentrate material (untreated). For example, note the reduced intensities of bitter taste, raw/green beany, earthy/dirty, and savory flavors. Among de-flavored batches, all samples in the legend are listed in order from most intense flavor to least intense flavor, which matches the order in Table 1.

With reference to FIG. 1 and Table 1 it is seen that all variable effect the flavor intensity of de-flavored pea protein concentrates.

Selected de-flavored pea protein concentrates, following de-flavoring, were measured for particle size using Malvern particle size analyzer. Results are reported as particle size (particle diameter) in microns and provide the D10, D50 and D90 particle size representing particle size of particles in the 10th, 50th and 90th percentile (i.e. 10% or particles smaller than, 50% particles smaller, or 90% particles less than). Results are reported in Table 3.

Note that Tables 1 and 3 are presented in flavor rank order with the most intensely flavored de-flavored pea protein concentrate at the top (PC1320) and the least intensely flavored pea protein concentrate at the bottom.

TABLE 3
Particle Size Analysis of De-Flavored Pea Protein Concentrates

| Sample | D10 (microns) | D50 (microns) | D90 (microns) |
|---|---|---|---|
| PC1320 | 2.505 | 12.05 | 47.55 |
| PC1230 | 3.55 | 18.10 | 82.40 |
| PC1140 | N/A | N/A | N/A |
| PC1210 | N/A | N/A | N/A |
| PC1100 | N/A | N/A | N/A |
| PC0935 | 3.69 | 17.35 | 75.20 |
| PC1020 | 3.48 | 16.85 | 71.90 |
| PC1125 | 4.29 | 22.75 | 107.5 |

### Example 3—Characterization of Percent Change of Denaturation Enthalpy of Pulse Protein Concentrate

Five additional samples of de-flavored pea protein concentrate were made using the de-flavoring parameters used for Sample PC1000. Two mill separation rates were used to optimize balance between flavor profile and protein damages (as measured by percent change of denaturation enthalpy.) Separator Mill Speed used on de-flavored pea protein concentrate after separation (Hosokawa Air Classifying Mill), particle size and flavor ranking. Flavor profiles were evaluated as described in Example 2. Particle size, reports diameter measured using Malvern particle size analyzer and reports particle size in microns as diameters of particles at D10, D50 and D90. Particle size also reports percent of particles able to pass through a 100-mesh size sieve (149 microns). The foregoing values are reported in Table 4.

TABLE 4
Various Parameters of Optimized De-Flavored Pea Protein Concentrate

| | Mill | | | | | % Through |
|---|---|---|---|---|---|---|
| | Separator | Flavor | D10 | D50 | D90 | 100-mesh |
| Sample | Speed (RPM | Rank | (microns) | (microns) | (microns) | (149 microns) |
| PC0945 | 1050 | 4 | 5.24 | 31.95 | 139.0 | 96.76 |
| PC1050 | 1050 | 3 | 4.51 | 27.10 | 131.5 | 95.96 |
| PC1305 | 1150 | 2 | 4.05 | 22.90 | 120.0 | 97.2 |
| PC1415 | 1150 | 1 | 3.86 | 21.25 | 114.5 | 99.8 |
| PC1156 | 1150 | NR | 4.70 | 30.40 | 136.5 | 96.3 |

With reference to Example 1, samples are generally in line with expectations. Optimized samples are larger, and it was found within the particle size range, the coarser samples had less intense flavor.

Samples reported in Table 4 were measured for percent change in denaturation enthalpy to assess the level of protein damage. Denaturation enthalpy was measured using differential scanning calorimetry (“DSC”). Measurements were made as follows: samples were prepared at 5% (w/v) protein in water in a high-volume stainless DSC pan. A reference pan was prepared with equal weight of water only. The sample and reference pans were heated at 2° C. per minute from 20° to 100° C.

Denaturation enthalpy of de-flavored pea protein concentrates and percent change in denaturation enthalpy between a base pea protein concentrate and the de-flavored pea protein concentrates is reported in Table 5.

TABLE 5
Denaturation Enthalpy of De-Flavored Pea Protein Concentrates

| | | Percent Change |
|---|---|---|
| | Denaturation | Denaturation |
| Sample | Enthalpy (J/g) | Enthalpy (%) |
| Base pea Protein Concentrate | 5.19 | N/A |
| PC0945 | 4.22 | 18.7 |
| PC1050 | 4.16 | 19.9 |
| PC1305 | 4.15 | 20.1 |
| PC1415 | 4.00 | 22.9 |
| PC1156 | 4.15 | 20.0 |

As further comparison, although not optimized to minimize protein damage, Sample PC1320, reported in Table 1, had denaturation enthalpy of 3.42 J/g. Further with reference to FIG. 1, it is noted that Sample PC1320 had the most intense cooked beany flavor suggesting that Sample PC1320 was overcooked. With reference to the flavor intensity rankings, it seen that the samples have the least intense flavor had more protein damage. Without being bound by theory it is suspected that some amount of protein damage is needed to but that the protein concentrate can be overcooked, which increases flavor. So particle size and processing conditions should be balanced to optimize de-flavoring.

### Example 4—Water Solubility of Deflavored Pea Protein Concentrates

De-flavored pea protein concentrates were evaluated for percent solubility of protein. Percent protein solubility of a de-flavored pea protein concentrate was determined using a modified method of Morr et al. (J. Food Science 50 (1985) 1715-et seq.) and Karaca et al (Food Res. Int'l 44 (2011) pp. 2742-2750). Protein solutions were prepared by dispersing 1% w/v of protein in buffer with pH adjustment to 7 with either 0.1 M NaOH or 0.1 M HCl as needed. Following establishing desired pH, protein concentrate was mixed with solution (solution into protein) by vortexing for 30 sec for 1 hour followed by centrifuging at 4000×g for 10 min at room temperature. The nitrogen content of the supernatant was determined using LECO protein analyzer (LECO, TruMac® N). Percent protein solubility was calculated by dividing the nitrogen content of the supernatant by the total nitrogen in the sample (x100%).

Percent soluble protein in a de-flavored pea protein concentrate is reported in Table 6.

TABLE 6
Percent Soluble Protein in De-Flavored Pea Protein Concentrate

| Batch | % Soluble Protein (w/w) |
|---|---|
| Base pea protein concentrate | about 80% |
| PC0945 | 53 |
| PC1050 | 54 |
| PC1305 | 52 |
| PC1415 | N/A |
| PC1156 | 52 |

De-flavored pea protein concentrates have less soluble protein content than base pea protein concentrates. But it is seen that samples have less protein damage have higher percent soluble protein showing the importance of designing de-flavoring process that minimize protein damage.

### Example 5—Use of De-Flavored Pea Protein Concentrates in Emulsions

It is expected that the de-flavored pea protein concentrates will make useful emulsions. A common recipe for a dressing style emulsion at 30% and 50% oil load is provided in Table 7.

TABLE 7
Emulsions Using De-Flavored Pea Protein Concentrates

| Ingredient | Wt. % | Wt. % |
|---|---|---|
| Water | 49.8 | 31.8 |
| CWS Starch | 4.5 | 2.5 |
| Vinegar (120 Grain) | 8.13 | 8.13 |
| Sugar | 5 | 5 |
| Mustard Powder | 0.23 | 0.23 |
| De-flavored pea protein concentrate | 0.5 | 0.5 |
| Paprika | 0.07 | 0.07 |
| Salt | 1.69 | 1.69 |
| EDTA | 0.01 | 0.01 |
| Potassium Sorbate | 0.07 | 0.07 |
| Soybean Oil | 30 | 50 |
| Total | 100% | 100% |

Using the formulas of Table 7, emulsions can be made by mixing all ingredients except soybean oil into water and vinegar using a stand mixer until well mixed. Soybean oil is then added to the aqueous mixture at medium speed to form a coarse emulsion, which is then transferred to a high shear mixers (e.g. Scott Turbon Mixer) to further homogenize the emulsions. Final homogenization is done at about 30 hertz for about 2 minutes.

Finished can be evaluated for oil droplet size using particle size analysis for example using Beckman Coulter particle size analyzer by the MIE model with a refractive index standardized to vegetable oil. Oil droplet size is useful to evaluating and predicting emulsions stability over time. It is expected the de-flavored pea protein concentrates will form emulsions having oil droplet size between about 10 and about 30 micron and whether measuring fresh samples, or samples that are stored at 4° C. for at least 1, 3, 6, or 12 months.

### Example 6—Reduction of Volatile Compounds in De-Flavored Pea Protein Concentrate

Effect of the de-flavoring process on the presence of certain volatile compounds associated causing flavor, aroma or both was evaluated using gas chromatography and mass spectroscopy (GC/MS). De-flavored pea protein concentrates were made in a hollow-tube reactor using processing conditions as described in the foregoing examples.

Results are presented as the percent change in the area response for defined compounds detected using GC/MS. The percent change compared area response for compounds in untreated base pea protein concentrate (obtained using an air classification process) with de-flavored pea protein concentrate. GS/MC process was done as follows.

Extraction of volatile flavor compounds from a sample containing pulse proteins was done using saturated sodium chloride solution and heat. A small amount of deuterated hexanal was added as an internal standard to a headspace vial containing the protein and saturated sodium chloride solution. The vial was incubated while a solid phase microextraction (SPME) fiber adsorbed the volatile compounds from the headspace (Divinylbenzene/Carboxen/Polydimethylsiloxane (DVB/CAR/PDMS) SPME fibers 1 cm (p/n 57298-U)). The fiber was then desorbed into a GC/MS where the eluted volatile compounds were searched against the NIST Mass Spectral Search Program and identities were verified against published NIST retention time indexes. Relative quantitation for each identified compound was then performed using mass spectrometry response versus the internal standard response. A DB-WAX UI (60 m×0.25 mm×0.25 μm) was applied as stationary phase with helium as the carrier gas.

Solutions/Indicators were prepared as follows. Saturated sodium chloride solution was made by placing 250 grams of sodium chloride in a 500 mL container. Fill the remaining container space with de-ionized Milli-Q water. Internal standard was made as follows. Transferred 10 μL of hexanal-d6 into 1 ml of methanol-d4 on the balance in a tared 1.5 mL screw cap vial.

Sample Preparation was a follows. Prepared in duplicate, 2.0 g of protein material or 4 mL of protein solution was weighed into a 20 mL headspace vial with SPME cap. 5 μL of internal standard was added. 4 mL of saturated sodium chloride solution is added to solid samples. If solids are slurries or high moisture approximately 1 g sodium chloride was added instead of the sodium chloride solution. The vial was capped and transfer to instrument tray.

Results are reported in Table 8. Results absolute values are reported in parts-per-million (PPM).

TABLE 8
Percent Reduction In Area Response From Gas
Chromatography/Mass Spectroscopy Between
De-Flavored And Untreated Pea Protein Concentrates

| | | | Average | |
|---|---|---|---|---|
| | | Average | Area | |
| | | Area | Response | |
| | | Response | (PPM) | |
| | | (PPM) | (untreated | % |
| | | (De-flavored | pea | Re- |
| | | Pea Protein | protein | duc- |
| CAS No. | Chemical Name | Concentrate) | concentrate) | tion |
| 123-38-6 | PROPANAL | 0.1 | 11.9 | 99 |
| 67-64-1 | 2-Propanone | 1.3 | 11.2 | 89 |
| 78-93-3 | 2-Butanone | 0.9 | 3.0 | 70 |
| 64-17-5 | Ethanol | 0.3 | 4.5 | 94 |
| 110-62-3 | Pentanal | 0.4 | 32.3 | 99 |
| 108-88-3 | Benzene, | 0.6 | 3.5 | 84 |
| | methyl- | | | |
| 66-25-1 | Hexanal | 4.7 | 309.0 | 98 |
| 616-25-1 | 1-Penten-3-ol | 0.4 | 30.8 | 99 |
| 110-43-0 | 2-Heptanone | 0.2 | 23.7 | 99 |
| 3777-69-3 | Furan, 2-pentyl- | 0.2 | 49.4 | 100 |
| 71-41-0 | 1-Pentanol | 0.5 | 32.9 | 99 |
| 124-13-0 | Octanal | 0.0 | 2.0 | 99 |
| 111-27-3 | 1-Hexanol | 0.5 | 560.4 | 100 |
| 124-19-6 | Nonanal | 0.5 | 7.5 | 94 |
| 1669-44-9 | 3-Octen-2-one | 0.0 | 18.0 | 100 |
| 2363-89-5 | 2 OCTENAL | 0.1 | 10.3 | 99 |
| 64-19-7 | Acetic acid | 0.6 | 22.9 | 97 |
| 3391-86-4 | 1-Octen-3-ol | 1.1 | 24.9 | 95 |
| 111-70-6 | 1-Heptanol | 0.1 | 36.5 | 100 |
| 100-52-7 | Benzaldehyde | 0.2 | 4.6 | 95 |
| 18829-56-6 | (E)-non-2 enal | 0.0 | 3.0 | 100 |
| 111-87-5 | 1-Octanol | 0.1 | 8.8 | 98 |
| 38284-27-4 | 3,5-Octadien- | 0.1 | 3.9 | 99 |
| | 2-one | | | |
| 18409-17-1 | 2-Octen-1-ol, | 0.1 | 0.6 | 84 |
| | (E)- | | | |
| 143-08-8 | 1-Nonanol | 0.0 | 8.0 | 100 |
| 503-74-2 | Butanoic acid, | 1.1 | 3.7 | 69 |
| | 3-methyl- | | | |
| 107-92-6 | Butanoic acid | 1.1 | 3.7 | 69 |
| 142-62-1 | Hexanoic acid | 0.1 | 57.6 | 100 |

As shown the de-flavoring process described in this specification significantly reduce various volatile chemicals present in an untreated pea protein concentrate.

1. A de-flavored pea protein concentrate comprising:
a. a pea protein content in a range from about 30% to about 75% (wt. % of the concentrate)
b. and a protein denaturation enthalpy from about 3.75 to about 5.0 J/g,

2. The de-flavored pea protein concentrate of claim 1 further comprising a particle size distribution having a D50 from about 10 to about 35 microns.

3. (canceled)

4. (canceled)

5. (canceled)

6. The de-flavored pea protein concentrate of claim 1 further having a percent soluble pea protein from about 50% to about 60%.

7. The de-flavored pea protein concentrate of claim 1 that is not enzymatically or chemically modified.

8. The de-flavored pea protein concentrate of claim 1 having a % reduction of at least 65% (measured using the GC/MS method provided in this specification) of at least one chemical present in an untreated pea protein concentrate wherein, optionally, chemical present in an untreated pea protein concentrated is at least one of acetaldehyde, propanal, 2-propanone, 2-butanone, ethanol, pentanal, benzene, methyl-hexanal, 1-penten-3-ol, 2-heptanone, furan, 2-pentyl-1-pentanol, octanal, 1-hexanol, nonanal, 3-octen-2-one, 2 octenal, acetic acid, 1-octen-3-ol, 1-heptanol, benzaldehyde, (e)-non-2 enal, 1-octanol, 3,5-octadien-2-one, 2-octen-1-ol, (e)-1-nonanol, butanoic acid, 3-methyl-butanoic acid, hexanoic acid.

9. (canceled)

10. (canceled)

11. (canceled)

12. A method for making a de-flavored pea protein concentrate comprising:
a. applying an aqueous fluid to a base pea protein concentrate to obtain a moistened pea protein concentrate;
b. heating the moistened legume flour at a temperature from about 140° C., to about 200° C., to obtain to obtain a heat-treated pea protein concentrate;
C. and milling the heat-treated pea protein concentrate to obtain the de-flavored pea protein concentrate;
wherein the applying step comprises applying an aqueous steam to the base pea protein concentrate in a ratio (concentrate to water) of from about 7:1 to about 12:1,

13. The method of claim 12 wherein the milling uses a classifying mill to separate at least a part of the heat-treated pea protein concentrate.

14. The method of claim 12 wherein the milling uses a classifying mill that separates at least a part of the heat-treated pea protein concentrate to obtain the de-flavored pea protein concentrate wherein the obtained de-flavored pea protein concentrate has a particle size distribution having a D50 from about 10 to about 35 microns,

15. (canceled)

16. The method of claim 12 wherein the milling uses an air classifying mill capable of separating at least a part of the heat-treated pea protein concentrate using separator having variable rotational speed and separating at least a portion of the heat-treated pea protein concentrate using a rotational speed of from about 1000.

17. The method of claim 12 wherein the applying and heating steps take place in a hollow tube reactor or a fluidized bed reactor.

18. The method of claim 12 wherein the heating is for a time from about 1 to 2 minutes to obtain the heat-treated pea protein concentrate.

19. The method of claim 12 further comprising drying the heat-treated pea protein concentrate to a moisture content from about 4% to about 15% (wt. %) with an air flow having a temperature from about 140° C. to about 160° C.

20. The method of claim 12 wherein the applying step and heating step occur in a hollow tube of a hollow tube reactor, the reactor further comprising a rotor within the hollow tube of the hollow-tube reactor; and
wherein the rotor is rotated at a rate from about 400 to about 900;

21. The method of claim 12 wherein the applying step and heating step are done in a first hollow-tube reactor and the de-flavored pea protein concentrate is dried in a second hollow-tube reactor.

22. The method of claim 12 further comprising, prior to step a) separating at least part of a protein from a base pea flour to obtain the base pea protein concentrate.

23. The method of claim 12 further comprising, prior to step a) providing a base pea flour comprising a pea protein and separating part of the pea protein from the base pea flour using a process that does not denature the protein in the flour.

24. The method of claim 12 further comprising, prior to step a) providing a base pea flour comprising a pea protein and separating part of the pea protein from the base pea flour using an air classifying process.

25. (canceled)

26. (canceled)

27. A food composition comprising a de-flavored pea protein concentrate comprising: a pea protein content in a range from about 30% to about 75% (wt. % of the concentrate) and a protein denaturation enthalpy from about 3.75 to about 5.0 J/g, and a second edible ingredient.

28. The food composition of claim 27 being a baked good, which has a flour component that consists of all the flour within the baked good, and wherein the flour component comprises de-flavored legume flour in an amount of at least about 10%.

29. The food composition of claim 27 being an oil in water emulsion comprising:
a. an oil content of greater than about 25%, and
b. de-flavored pea protein concentrate as described in any foregoing claim in an amount from about 0.1% to about 5%.
